(19) United States
(12) Patent Application Publication
(10) Pub. No.: US 2010/0327713 A1
(43) Pub. Date: Dec. 30, 2010

(54) COMPUTER ENCLOSURE

(75) Inventors: WEI-JUN WANG, Shenzhen City (CN); ZI-MING TANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/582,852

(22) Filed: Oct. 21, 2009

(30) Foreign Application Priority Data
Jun. 26, 2009 (CN) 200910303751.X

(51) Int. Cl. A47B 81/00; E05B 65/00

(52) U.S. Cl. 312/223.2; 70/158

(57) ABSTRACT

A computer enclosure includes a housing, a cover, and a locking mechanism assembling the cover to the housing. The locking mechanism includes a latch piece formed on the housing, a guide member formed on the cover, a lock rod slidably extending through the guide member, and an operating member slidably assembled on the cover and connected to the lock rod. The latch piece defines a latch hole. The operating member is moves the lock rod to engage in or disengage from the latch hole such that the cover is locked to or detached from the housing.

### BACKGROUND

1. Technical Field

The present disclosure relates to an enclosure for a computer.

2. Description of Related Art

A typical computer enclosure includes a housing and a cover. The housing defines a cavity to receive electronic components, such as a main board, a hard disk, and so on. The cover is fixed on an opening of the housing to enclose the cavity. Generally, the cover is fixed on the housing by screws or bolts. However, this can be inconvenient for assembly or removal, because screws or bolts must be screwed or unscrewed one by one. In addition, the computer enclosure may easily deform after multiple assemblies or disassemblies.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an embodiment of a computer enclosure.

FIG. 2 is a cutaway view of the computer enclosure in FIG. 1.

FIG. 3 is an exploded, isometric view of the computer enclosure in FIG. 2.

FIG. 4 is a partial cross section of the computer enclosure taken along line IV-IV in FIG. 1.

FIG. 5 is an enlarged, isometric view of a portion V of the computer enclosure in FIG. 3.

FIG. 6 is an enlarged, isometric view of a portion VI of the computer enclosure in FIG. 3.

FIG. 7 is a partial cross section of the computer enclosure taken along line VII-VII in FIG. 1.

FIG. 8 is similar to FIG. 7, but showing another working state.

### DETAILED DESCRIPTION OF THE EMBODIMENTS

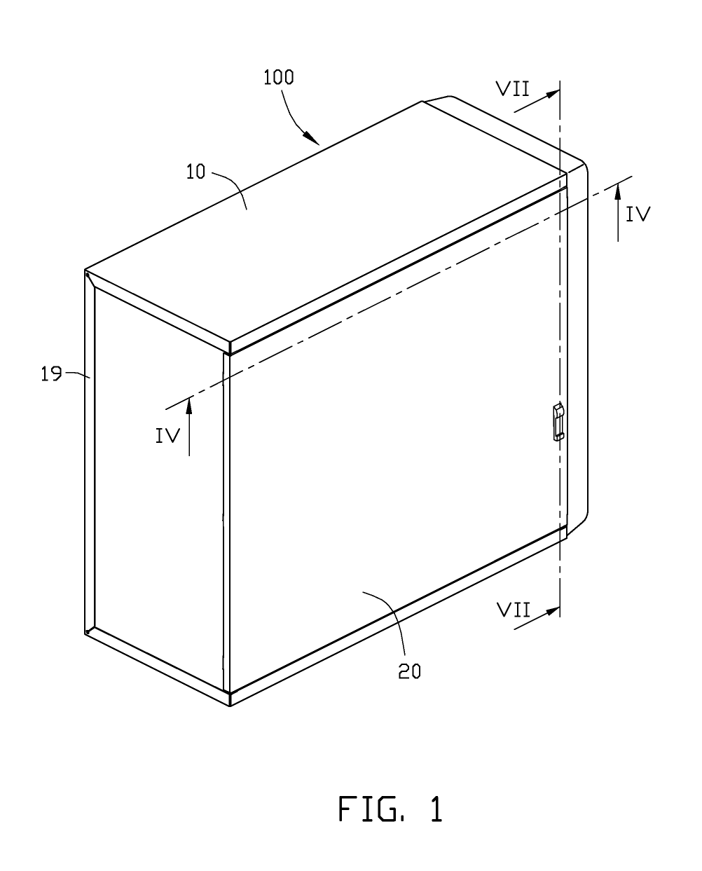

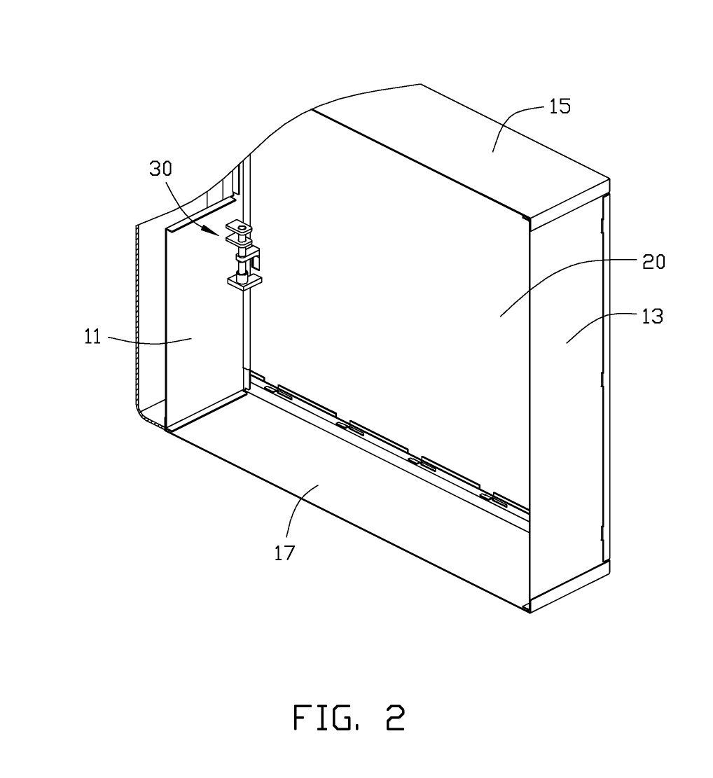

Referring to FIGS. 1 and 2, an embodiment of a computer enclosure 100 includes a housing 10, a cover 20, and a locking mechanism 30 to fix the cover 20 on the housing 10.

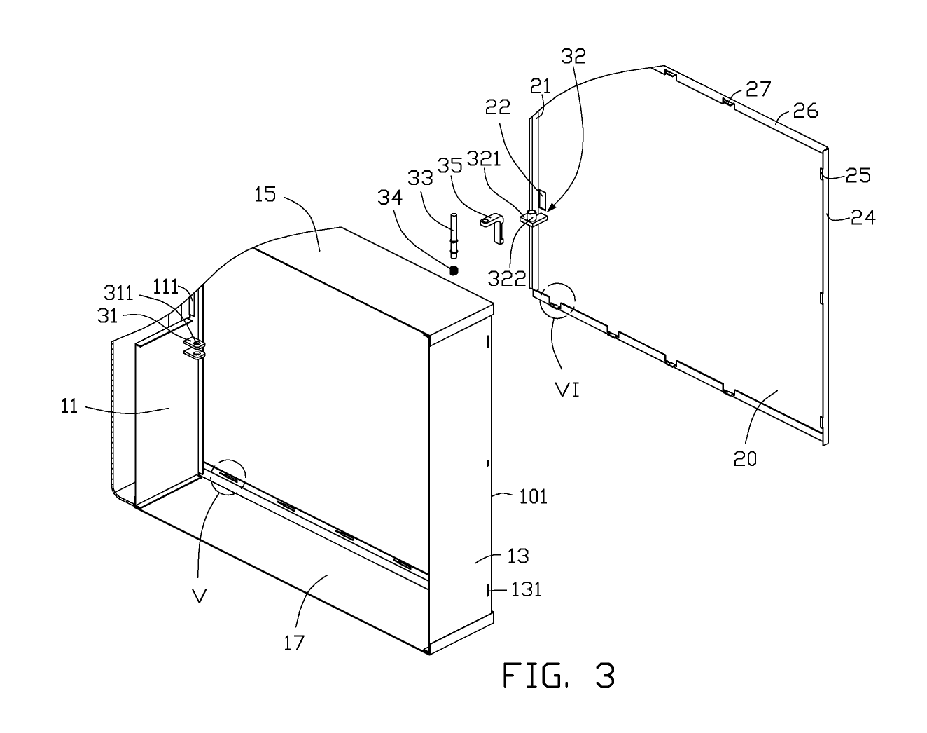

Referring also to FIG. 3, the housing 10 includes a substantially rectangular side plate 19, and a front plate 11, a rear plate 13, an upper plate 15, a bottom plate 17 extending substantially perpendicular from the four sides of the side plate 19. The above plates cooperatively define a cavity (not labeled) to receive electronic components (not shown). The housing 10 has an opening 101 on which the cover 20 is fixed.

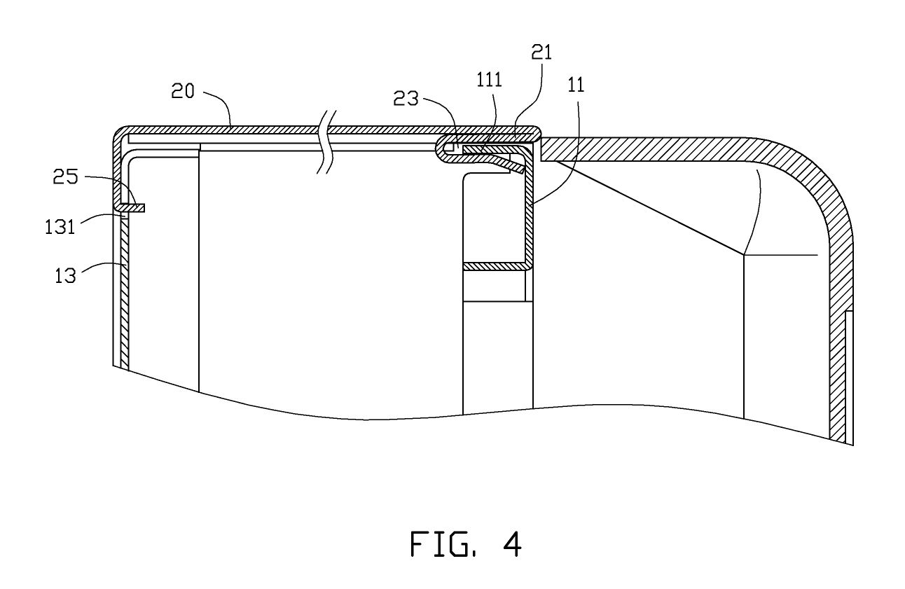

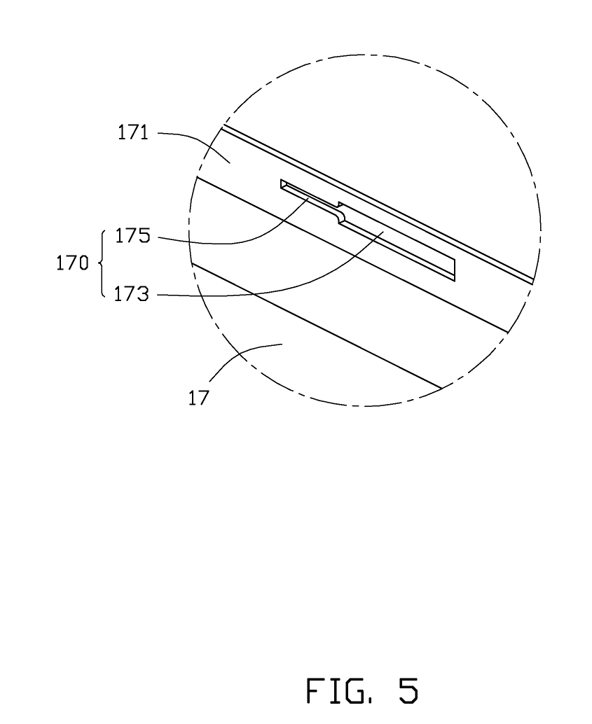

Referring also to FIGS. 4 and 5, the front plate 11 forms a bent portion 111 adjacent to the opening 101. The rear plate 13 defines a plurality of fixing holes 131 adjacent to the opening 101. The upper plate 15 and the bottom plate 17 both form a bent portion 171 adjacent to the opening 101. The bent portion 171 defines a plurality of engaging holes 170, wherein each engaging hole 170 includes a sliding portion 173 and an engaging portion 175 narrower than the sliding portion 173.

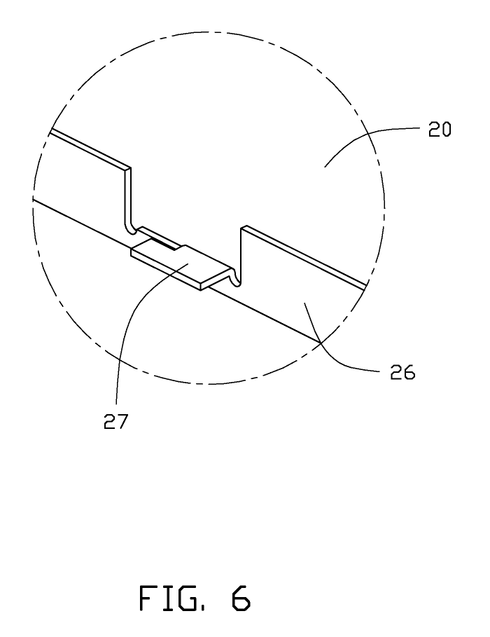

Referring also to FIG. 6, the cover 20 is a substantially rectangular plate. A first side of the cover 20 adjacent to the front plate 11 forms a latching portion 21, and defines a through hole 22. The latching portion 21 defines a latching groove 23 to receive the bent portion 111 of the front plate 11. A second side of the cover 20 adjacent to the back plate 13 forms a bent portion 24. The bent portion 24 forms a plurality of fixing tabs 25 corresponding to the fixing holes 131. A third side and a fourth side of the cover 20 respectively adjacent to the upper plate 15 and the bottom plate 17 both form a bent portion 26. Each bent portion 26 forms a plurality of engaging tabs 27 corresponding to the engaging holes 170.

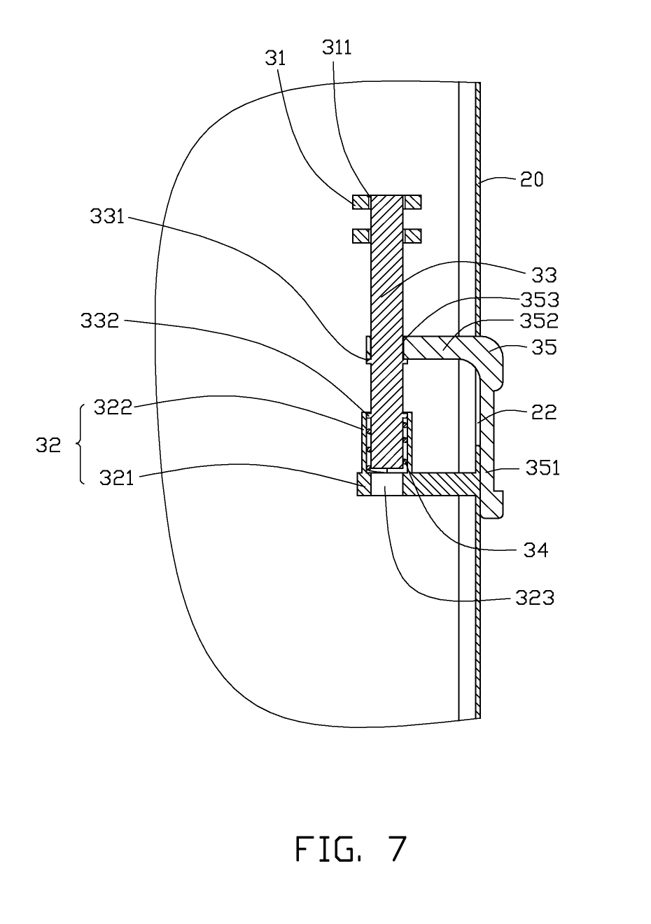

Referring also to FIG. 7, the locking mechanism 30 includes two latch pieces 31, a guide member 32, a lock rod 33, an elastic member 34, and an operating member 35. The latch pieces 31 are formed on the housing 10. The guide member 32 is formed on the cover 20. The lock rod 33 slidably extends through the guide member 32. The elastic member 34 is sleeved on the lock rod 33 and positioned in the guide member 32. The operating member 35 is connected to the lock rod 33 and engages the lock rod 33 with the latch pieces 31.

The latch pieces 31 extend substantially perpendicularly from a side of the front plate 11 adjacent to the opening 101. The two latch pieces 31 are substantially parallel and each latch piece 31 defines a latch hole 311 in the center thereof, receiving the lock rod 33.

The guide member 32 includes a protruding stage 321 formed on the first side of the cover 20 adjacent to the through hole 22, and a guide sleeve 322 formed on the top surface of the protruding stage 321. The protruding stage 321 defines a guide hole 323 to allow the lock rod 33 to extend through.

The lock rod 33 is substantially cylindrical, and forms a first flange 331 on the middle portion, and a second flange 332 adjacent to the bottom end of the lock rod 33. The diameter of the cross section of the lock rod 33 is slightly smaller than the diameters of the latch holes 311, and the guide hole 323. Thus, the lock rod 33 can be slidably received in the latch holes 311, and the guide hole 323.

In the illustrated embodiment, the elastic member 34 is a helical spring. Alternatively, the elastic member 34 may be a plurality of spring washers, elastic rubber rings, or elastic cylinders.

The operating member 35 is substantially L-shaped, and includes an operating portion 351 and a connection portion 352, the connection portion 352 defines a positioning hole 353 receiving the lock rod 33.

During assembly, the elastic member 34 is positioned in the guide sleeve 322. The lock rod 33 extends through the guide sleeve 322, and the second flange 332 abuts the elastic member 34. The connection portion 352 of the operating member 35 extends through the through hole 22 from the outside of the cover 20, and the connection portion 352 sleeves on the lock rod 33 and abuts the first flange 331.

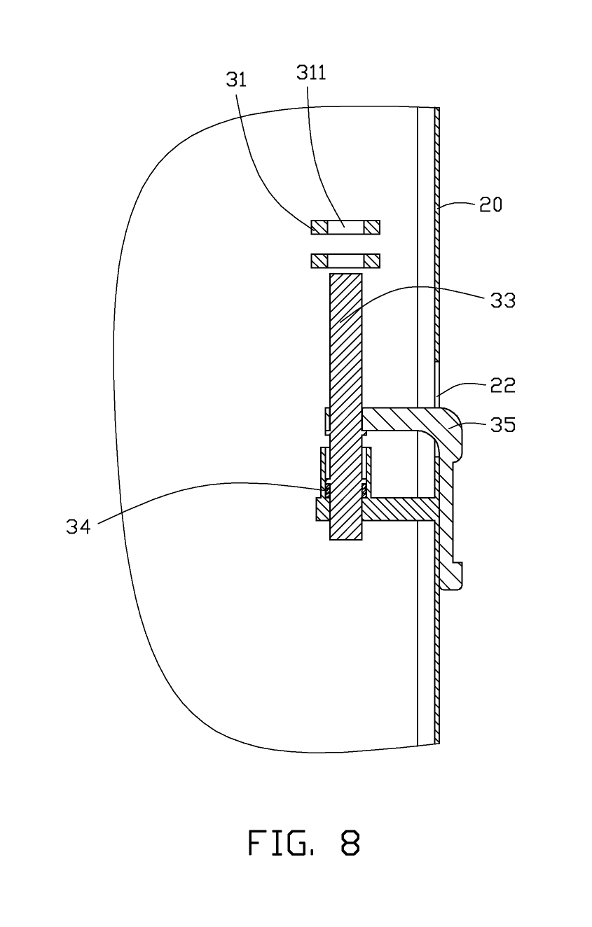

Referring also to FIG. 8, assembly of the cover 20 onto the housing 10 begins by first inserting the engaging tabs 27 of the cover 20 in the sliding portions 173 of the housing 10. External force on the operating portion 351 lowers the operating member 35. The connection portion 352 abuts the first flange 331 to further lower the lock rod 33, disengaging the lock rod 33 from the latch holes 311 of the latch pieces 31. At this point, the bottom end of the lock rod 33 is received in the guide hole 323. The elastic member 34 is compressed by the second flange 332. The cover 20 is then moved by the external force towards the front plate 11, until the engaging tabs 27 engage the engaging portions 175. At the same time, the bent portion 111 of the front plate 11 latches in the latching groove 23 of the cover 20. The fixing tabs 25 of the cover 20 engage the fixing holes 131 of the housing 10. Subsequently, the external force is released on the operating member 35, the lock rod 33 moves upwards and engages the latch holes 311 of the latch pieces 31 due to the elastic force generated by the elastic member 34. The cover 20 is thus assembled on the housing 10.

The cover 20 is removed from the housing 10 by lowering the operating member 35 and the lock rod 33 with an external force, which disengages from the latch holes 311 of the latch pieces 31. The cover 20 is then moved by the external force away from the front plate 11, until the engaging tabs 27 slide in the sliding portions 173. At the same time, the bent portion 111 of the front plate 11 is disengaged from the latching groove 23 of the cover 20. The fixing tabs 25 of the cover 20 are disengaged from the fixing holes 131 of the housing 10. The cover 20 is thus easily removed from the housing 10.

In alternative embodiments, the number of latch pieces 31 may vary, the connection portion 352 of the operating member 35 may be fixed on the lock rod 33, rendering the first flange 331 unnecessary, and the elastic member 34 may be omitted, such that the operating member 35 is raised and lowered by external force alone, engaging the lock rod 33 in the latch holes 311, and being positioned on the cover 20 by an engaging or latching means.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A computer enclosure, comprising:
a housing;
a cover; and
a locking mechanism assembling the cover to the housing, the locking mechanism comprising:
a latch piece formed on the housing, and defining a latch hole;
a guide member formed on the cover;
a lock rod slidably received in the guide member; and
an operating member slidably assembled on the cover and connected to the lock rod, wherein the operating member is capable of driving the lock rod to engage in or disengage from the latch hole such that the cover is locked to or detached from the housing.

2. The computer enclosure of claim 1, wherein the locking mechanism further comprises an elastic member sleeved on the lock rod and positioned in the guide member;
the lock rod comprising a flange abutting the elastic member.

3. The computer enclosure of claim 2, wherein the guide member comprises a protruding stage on the cover, and a guide sleeve formed on the protruding stage; the elastic member is disposed in the guide sleeve and the protruding stage defines a guide hole receiving the lock rod.

4. The computer enclosure of claim 1, wherein the cover defines a through hole and the operating member comprises a connection portion extending through the through hole and an operating portion positioned on the outside of the cover; wherein the connection portion is connected to the lock rod.

5. The computer enclosure of claim 4, wherein the lock rod comprises a flange, the connection portion of the operating member defines a positioning hole receiving the lock rod, and the connection portion abuts the flange of the lock rod.

6. The computer enclosure of claim 4, wherein the connection portion of the operating member is fixed on the lock rod.

7. The computer enclosure of claim 1, wherein the housing and the cover each comprises a bent portion, the bent portion of the housing defining a plurality of engaging holes, each engaging hole comprising a sliding portion and an engaging portion narrower than the sliding portion, and the bent portion of the cover comprising a plurality of engaging tabs slidably received in the sliding portions and engaged in the engaging portions.

8. The computer enclosure of claim 1, wherein the housing and the cover each comprise a bent portion, the bent portion of the housing defining a plurality of fixing holes, and the bent portion of the cover comprising a plurality of fixing tabs engaged in the fixing holes.

9. The computer enclosure of claim 1, wherein the housing comprises a bent portion, and the cover comprises a latching portion defining a latching groove to receive the bent portion of the housing.

10. A computer enclosure, comprising:
a housing;
a cover assembled to the housing; and
a locking mechanism comprising:
a latch piece formed on the housing, and defining a latch hole;
a guide member formed on the cover;
a lock rod slidably received in the guide member;
an elastic member sleeved on the lock rod and positioned in the guide member; and
an operating member slidably assembled on the cover and connected to the lock rod;
wherein the lock rod engages in the latch hole of the latch piece, locking the cover on the housing; and when force on the operating member moves the lock rod to compress the elastic member, the lock rod disengages from the latch hole of the latch piece, detaching the cover from the housing.

11. The computer enclosure of claim 10, wherein the guide member comprises a protruding stage on the cover, and a guide sleeve on the protruding stage; the elastic member is disposed in the guide sleeve, and the protruding stage defines a guide hole receiving the lock rod.

12. The computer enclosure of claim 10, wherein the cover defines a through hole and the operating member comprises a connection portion extending through the through hole and an operating portion positioned on the outside of the cover; wherein the connection portion is connected to the lock rod.

13. The computer enclosure of claim 12, wherein the lock rod comprises a flange, the connection portion of the operating member defines a positioning hole to receive the lock rod, and the connection portion abuts the flange of the lock rod.

14. The computer enclosure of claim 12, wherein the connection portion of the operating member is fixed on the lock rod.

15. The computer enclosure of claim 10, the housing and the cover each comprises a bent portion, the bent portion of the housing defining a plurality of engaging holes, each engaging hole comprising a sliding portion and an engaging portion narrower than the sliding portion, and the bent portion of the cover comprising a plurality of engaging tabs slidably received in the sliding portions and engaged in the engaging portions.

16. The computer enclosure of claim 10, wherein the housing and the cover each comprises a bent portion, the bent portion of the housing defining a plurality of fixing holes, and the bent portion of the cover comprising a plurality of fixing tabs engaged in the fixing holes.

17. The computer enclosure of claim 10, wherein the housing comprises a bent portion, and the cover comprises a latching portion defining a latching groove receiving the bent portion of the housing.
